(19) United States
(12) Patent Application Publication
(10) Pub. No.: US 2011/0251979 A1
(43) Pub. Date: Oct. 13, 2011

(54) SYSTEM AND METHOD OF AGGREGATING DOG HAIR

(76) Inventor: Billy J. Watterson, Algonquin, IL (US)

(21) Appl. No.: 12/758,745

(22) Filed: Apr. 12, 2010

(51) Int. Cl. G06Q 90/00; B65D 25/14; B65B 1/04; B65D 6/16

(52) U.S. Cl. 705/500; 220/666; 220/495.06; 53/473

(57) ABSTRACT

A system for aggregating dog hair for making yarn includes: dog hair collection facilities including one or more dog hair undercoat collectors; an aggregation facility that accepts the collected contents of the plurality of dog hair undercoat collectors; and a logistics system that manages the collection and transportation of the contents of the plurality of dog hair undercoat collectors from the plurality of dog hair collection facilities. A method for aggregating dog hair for making yarn includes: collecting dog hair undercoat from a plurality of dogs at dog hair collection facilities; aggregating the collected dog hair undercoat; and providing the aggregated dog hair undercoat to one or more mills.

### BACKGROUND OF THE INVENTION

The present subject matter relates generally to a system and method of aggregating dog hair. More specifically, the present invention relates to system and method of aggregating dog hair using a closed-loop logistics system.

On a national scale, dog grooming results in massive amounts of dog hair waste. This waste ends up in landfills stressing an already overtaxed system. It is known that dog hair, and specifically dog hair undercoat, can be turned into a usable product. As merely one example, it is known that dog hair undercoat may be spun with wool to create a functional and desirable yarn. However, until present, aggregating dog hair on the necessary scale to convert it to useful and functional forms has been cost prohibitive. For example, transportation of dog hair for aggregation is problematic because dog hair is a low-weight high-volume product.

Standard waste haulers can only haul material within a short range, which would require them to use multiple transfer stations to manage a waste stream back to an aggregation facility. In addition to the limits of traditional waste hauling capability, most waste haulers only handle certain markets within various communities where grooming centers are located. This creates a logistical nightmare because multiple carries may required within one city alone, let alone on a national (or larger) scale.

As a result, collecting, transporting, aggregating, manufacture of dog hair yarn is complex due to the nature of the materials weight and volume. Currently, there is no single waste management process that can handle collection and aggregation of dog hair efficiently, or cost effectively, such as, for example, on a regional or national scale.

Accordingly, a need exists for a system and method of aggregating dog hair as described and claimed herein.

### BRIEF SUMMARY OF THE INVENTION

The system and method of aggregating dog hair disclosed herein provides a solution for aggregation of dog hair waste and conversion to sellable material.

In one embodiment of the present subject matter, a dog hair aggregation system includes: a plurality of collection facilities within which dog hair collectors are located; a logistics system adapted to collect the dog hair collected in the dog hair collectors; and an aggregation facility wherein the dog hair from the plurality of dog hair collectors is aggregated.

In another embodiment of the present subject matter, a method of aggregating dog hair for making yarn includes the steps of: collecting dog hair undercoat at a plurality of dog hair collection facilities; aggregating the collected dog hair undercoat from the plurality of dog hair collection facilities; and providing the aggregated dog hair undercoat to one or more mills.

In yet another embodiment of the present subject matter, a method of aggregating dog hair includes the steps of: providing dog hair undercoat collectors at a plurality of locations; systematically collecting the dog hair undercoat from the plurality of dog hair undercoat collectors; and aggregating the dog hair undercoat collected from the plurality of dog hair undercoat collectors.

An advantage of the present subject matter is that it does not require internal corporate management of grooming facilities to successfully collect, remove, aggregate, track and process dog hair from thousands of locations nationwide.

Another advantage of the present subject matter is that it allows for the independent tracking of weight of hair removed from individual facilities to the ounce, allowing for accurate forecasting for the anticipated and actual volume of dog hair yarn that can be produced to be used for the creation of large scale saleable product to end users.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 is a block diagram of a system for aggregating dog hair.

FIG. 2 is another block diagram of a system for aggregating dog hair.

FIG. 3 is a flow chart illustrating a method of aggregating dog hair.

FIG. 4 is a flow chart illustrating another method of aggregating dog hair.

FIG. 5 is a flow chart illustrating another method of aggregating dog hair.

### DETAILED DESCRIPTION OF THE INVENTION

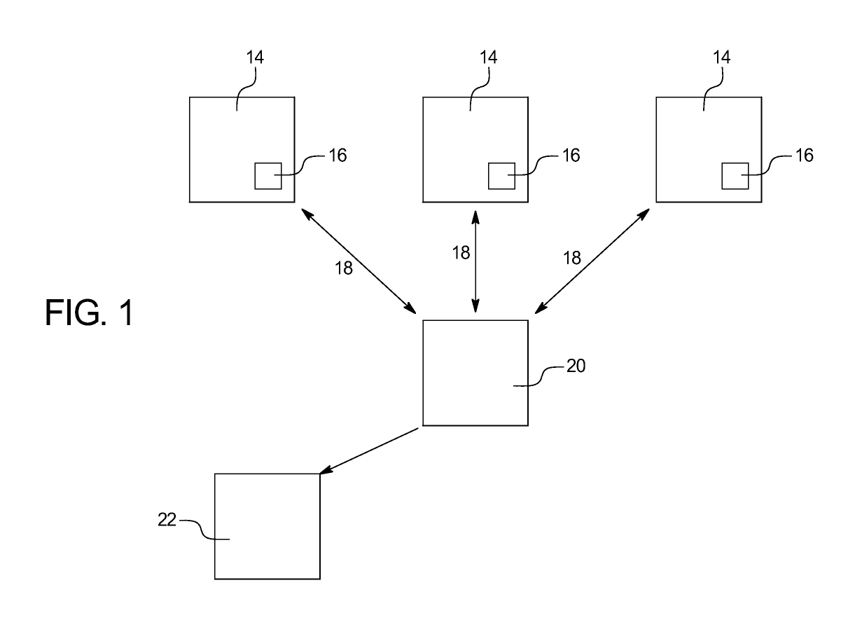

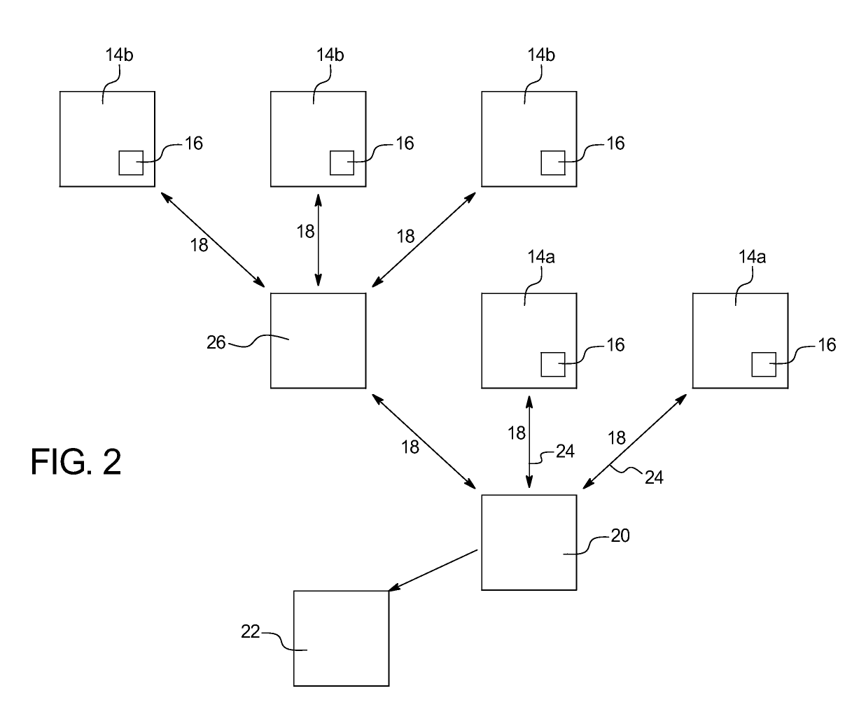

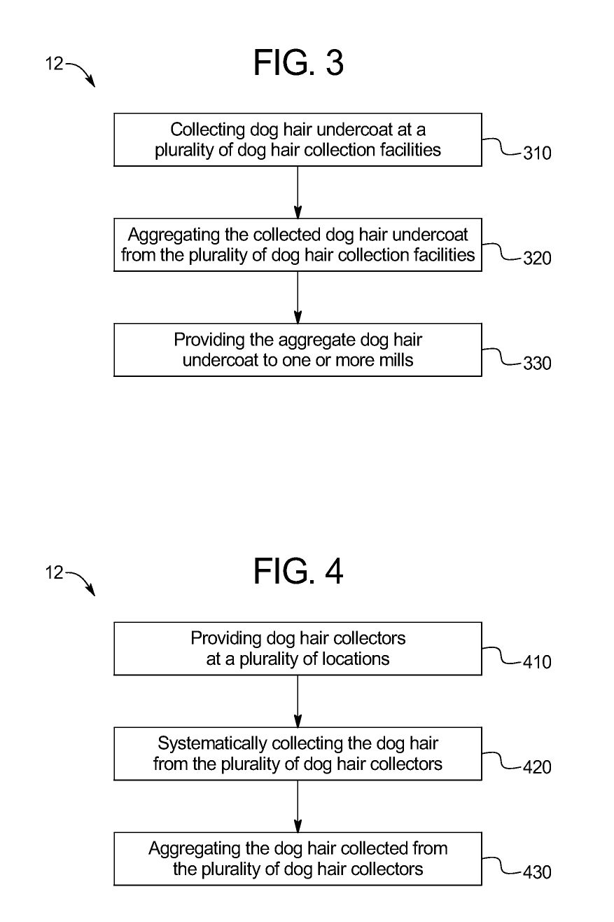

FIGS. 1 and 2 illustrate an example of a dog hair aggregation system 10. FIGS. 3, 4 and 5 illustrate methods of aggregating dog hair 12.

The embodiment of the dog hair aggregation system 10 shown in FIG. 1 includes: a plurality of collection facilities 14 within which dog hair collectors 16 are located; a logistics system 18 adapted to collect the dog hair collected in the dog hair collectors 16; and an aggregation facility 20 wherein the dog hair from the plurality of dog hair collectors 16 is aggregated. As further shown in FIGS. 1 and 2, the dog hair aggregation system may further include a mill 22 or other facility for using the aggregated dog hair.

In the example shown in FIG. 1, the collection facilities 14 are commercial dog grooming locations. For example, the collection facilities 14 may be pet store locations that include grooming facilities and services. It is contemplated that the efficiency of the system 10 may be improved by targeting high volume grooming locations. However, it is understood that any location for collecting dog hair may be utilized as a collection facility 14. For example, in the embodiment of the dog hair aggregation system 10 shown in FIG. 2, the plurality of collection facilities 14 includes high volume and low volume collection facilities 14. The low volume collection facilities 14 may be, for example, specialty grooming shops or other low volume facilities that generate dog hair waste.

The dog hair collectors 16 shown in FIGS. 1 and 2 may be any receptacle for storing dog hair. For example, the dog hair collectors 16 may be boxes, bags, containers, etc.

Depending on the intended use of the collected dog hair, the dog hair collectors 16 may be used to sort the dog hair prior to being collected by the logistics system 18. For example, the dog hair may be sorted into top coat and undercoat using a separate dog hair collector 16 for each or using a dog hair collector for one category and not the other. Alternately, the dog hair may be sorted into any categories, such as, for example, long hair, short hair, by color, by breed, etc.

In the examples shown in FIGS. 1 and 2, the dog hair collectors 16 are containers such as those disclosed in U.S. patent application Ser. No. 12/168,433, the entirety of which is incorporated herein by reference.

The logistics system 18 shown in FIGS. 1 and 2 is a collection, transportation and tracking system whereby the contents of the dog hair collectors 16 are transported from the collection facilities 14 to the aggregation facility 20. As shown in FIG. 1, the logistics system 18 may be provided such that the dog hair collectors 16 or the contents of the dog hair collectors 16 may collected from the plurality of collection facilities 14 and transported directly to the aggregation facility 20. In one contemplated example, the dog hair collectors 16 are physically transported to the aggregation facility 20. In another contemplated example, the dog hair collectors 16 include a portion that is removed from the whole (such as, for example, a removable sleeve), the removable portion being transported to the aggregation facility 20. In yet another contemplated example, the contents of the dog hair collectors 16 may be collected, while leaving the entirety of the dog hair collectors 16 themselves at the collection facilities 14.

In the example shown in FIG. 2, the logistics system 18 provides different paths from the collection facilities 14 to the aggregation facility 20 depending on the size of the collection facility 14. For example, as shown in FIG. 2, the logistics system 18 provides a direct path 24 between the high volume collection facilities 14a and the aggregation facility 20 and includes an intermediate collection process 26, wherein the collections from the low volume collection facilities 14b are locally aggregated before being transported to the aggregation facility 20. Accordingly, as shown, the efficiency of the system may be improved as needed to include a greater or lesser number of shipping and/or aggregating steps in the logistics system 18. For example, as shown in FIG. 2, aggregating the output from geographically clustered low volume collection facilities 14b prior to transportation to the aggregation facility 20 may result in lower transportation costs. Further, as shown in FIG. 2, it may be most efficient and cost effective to transport the collections from the high volume collection facilities 14a directly to the aggregation facility 20.

As shown in FIGS. 1 and 2, the aggregation facility 20 is the facility to which the dog hair is transported through the logistics system 18. It is understood that while shown as a single aggregation facility 20 in FIGS. 1 and 2, it is contemplated that the dog hair aggregation system 10 may be scaled to include any number of aggregation facilities 20.

In the examples shown in FIGS. 1 and 2, the aggregation facility 20 accepts the collected dog hair and aggregates it for use. In addition, the aggregation facility 20 may further weigh, sort, clean, etc. the dog hair as it is prepped for further use. In embodiments in which the dog hair collectors 16 are routed to the aggregation facility 20, the aggregation facility 20 may clean the dog hair collectors 16 before transporting them back to the collection facilities 14 through the logistics system 18.

As shown in FIGS. 1 and 2, in embodiments in which collected dog hair undercoat is to be spun into yarn, after the dog hair is aggregated, weighed, cleaned, and/or sorted in the aggregation facility 20, the dog hair is sent to a mill 22. Alternatively, the dog hair may be sent to other locations to be used in other processes.

In one contemplated embodiment, dog hair collectors 16 in the form of plastic corrugated boxes are drop shipped to designated collection facilities 14 nationwide. The corrugated boxes are accompanied with removable liners, cable ties (i.e., zip ties), and a pre-paid shipping label. When the dog hair collector 16 is received at the collection facility 14, the container is opened and erected and the liner is removed and placed inside of the container.

At the designated collection facilities 14, dog hair is separated into top coat and undercoat. The sorted dog hair is then placed into the dog hair collectors 16 until they are filled. Once a given dog hair collector 16 is filled, the liner is closed using the zip tie, the box is sealed and a package delivery company uses the pre-paid label to direct the material to the appropriate aggregation facility 20.

Once a dog hair collector 16 is received at an aggregation facility 20, the dog hair collector 16 is scanned to retrieve relevant data (for example, the dog hair collector 16 may include a bar code or other identification tag for tracking and identification purposes), any contamination is removed as much as reasonable (for example, any stray top coat may be removed), the dog hair is weighed and the weight data is associated with the scanned data. Next, the dog hair from multiple received dog hair collectors 16 is aggregated and forwarded to a mill 22 for processing into yarn. After the dog hair collector 16 boxes are emptied, they are broken down, cleaned, and repackaged for shipment back to the designated collection facilities 14.

The data collected in the process enables tracking of collection facility 14 level activity in terms of total weight of material received by each collection facilities 14, the number of dog hair collectors 16 they have on hand, and may be used to alert operators when new pre-paid boxes must be shipped.

While the embodiment described above is believed to be the most practical current logistics system 18, it is understood that alternative collection, transportation and tracking methods may be employed to accomplish the advantages of the subject matter herein and that developments in shipping systems may provide more efficient logistics systems 18 for use herein.

FIG. 3 illustrates one example of a method for aggregating dog hair 12. As shown in FIG. 3, the method of aggregating dog hair 12 includes the steps of: collecting dog hair undercoat at a plurality of dog hair collection facilities 310; aggregating the collected dog hair undercoat from the plurality of dog hair collection facilities 320; and providing the aggregated dog hair undercoat to one or more mills 330.

FIG. 4 illustrates another example of a method of aggregating dog hair 12. As shown in FIG. 4, the method of aggregating dog hair 12 includes the steps of: providing dog hair collectors at a plurality of locations 410; systematically collecting the dog hair from the plurality of dog hair collectors 420; aggregating the dog hair collected from the plurality of dog hair collectors and 430.

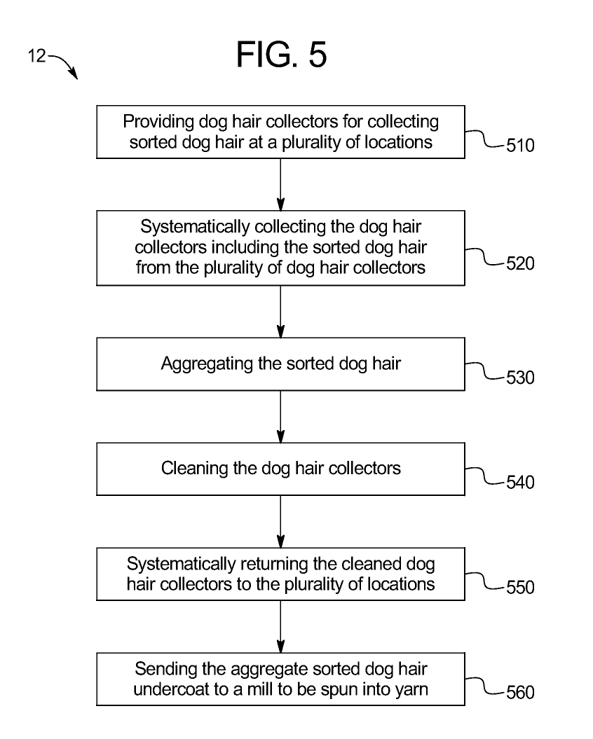

FIG. 5 illustrates another example of a method of aggregating dog hair 12. As shown in FIG. 5, the method of aggregating dog hair 12 includes the steps of: providing dog hair collectors for collecting sorted dog hair at a plurality of locations 510; systematically collecting the dog hair collectors including the sorted dog hair from the plurality of dog hair collectors 520; aggregating the sorted dog hair 530; cleaning the dog hair collectors 540; systematically returning the cleaned dog hair collectors to the plurality of locations 550; and sending the aggregated sorted dog hair undercoat to a mill to be spun into yarn 560.

It should be noted that various changes and modifications to the presently preferred embodiments described herein will be apparent to those skilled in the art. Such changes and modifications may be made without departing from the spirit and scope of the present invention and without diminishing its attendant advantages.

I claim:

1. A system for aggregating dog hair for making yarn comprising:
a plurality of dog hair collection facilities, wherein each collection facility includes one or more dog hair undercoat collectors;
an aggregation facility that accepts the collected contents of the plurality of dog hair undercoat collectors; and
a logistics system that manages the collection and transportation of the contents of the plurality of dog hair undercoat collectors from the plurality of dog hair collection facilities.

2. The system of claim 1 wherein the collection facilities include commercial dog grooming facilities.

3. The system of claim 1 wherein the dog hair undercoat collectors are collapsible plastic corrugated boxes.

4. The system of claim 3 wherein the collapsible plastic corrugated boxes include removable liners, cable ties and a pre-paid shipping label.

5. The system of claim 1 wherein the logistics system includes shipping mechanisms for transporting the dog hair undercoat collectors.

6. The system of claim 5 wherein the shipping mechanisms are provided by a commercial shipping company.

7. The system of claim 1 wherein the logistics system includes tracking mechanisms for tracking each dog hair undercoat collector.

8. The system of claim 7 wherein the tracking mechanisms track the weight of the dog hair undercoat collected and associate the weight data with the collection facility from which it is collected.

9. The system of claim 7 wherein the tracking mechanisms track the number of dog hair undercoat collectors at each collection facility and prompt a user to provide more dog hair undercoat collectors to a collection facility when predetermined conditions are met.

10. The system of claim 1 wherein the logistics system further manages the collection and transportation of the contents of the plurality of dog hair undercoat collectors from the aggregation facility to a mill.

11. A method of aggregating dog hair for making yarn comprising:
collecting dog hair undercoat at a plurality of dog hair collection facilities, wherein the dog hair undercoat at each dog hair collection facility is collected from a plurality of dogs;
transporting and aggregating the collected dog hair undercoat from the plurality of dog hair collection facilities; and
providing the aggregated dog hair undercoat to one or more mills.

12. The method of claim 11 wherein the dog hair undercoat is collected using collapsible plastic corrugated boxes.

13. The method of claim 12 wherein the plastic corrugated boxes include removable liners, cable ties and a pre-paid shipping label.

14. The method of claim 11 wherein a logistics system manages the transportation and aggregation of the dog hair undercoat.

15. The method of claim 11 wherein the dog hair undercoat collected from the dog hair collection facilities is transported by a commercial shipping company.

16. A method of aggregating dog hair for making yarn comprising:
providing a dog hair undercoat collectors at a plurality of locations, wherein each dog hair undercoat collector accepts dog hair undercoat from a plurality of dogs;
systematically collecting the dog hair undercoat from the plurality of dog hair undercoat collectors; and
aggregating the dog hair undercoat collected from the plurality of dog hair undercoat collectors.

17. The method of claim 16 wherein the dog hair undercoat collectors are collapsible plastic corrugated boxes.

18. The method of claim 16 wherein the collapsible plastic corrugated boxes include removable liners, cable ties and a pre-paid shipping label.

19. The method of claim 16 wherein the dog hair undercoat collectors are transported by a commercial shipping company.

20. The method of claim 16 wherein a logistics system manages the transportation and aggregation of the dog hair undercoat collectors.
